(19) United States
(12) Patent Application Publication
(10) Pub. No.: US 2026/0005262 A1
(43) Pub. Date: Jan. 1, 2026

(54) CARBON FIBER COMPOSITE FUEL CELL BIPOLAR PLATE

(71) Applicant: GM GLOBAL TECHNOLOGY OPERATIONS LLC, Detroit, MI (US)

(72) Inventors: Glenn W. Skala, Churchville, NY (US); Swaminatha P. Kumaraguru, Rochester Hills, MI (US); Bradley Allen Newcomb, Troy, MI (US)

(73) Assignee: GM GLOBAL TECHNOLOGY OPERATIONS LLC, Detroit, MI (US)

(21) Appl. No.: 18/754,187

(22) Filed: Jun. 26, 2024

(51) Int. Cl. H01M 8/0228; H01M 8/0221; H01M 8/0247; H01M 8/1004

(52) U.S. Cl. CPC H01M 8/0228; H01M 8/0221; H01M 8/0247; H01M 8/1004

(57) ABSTRACT

Composite fuel cell bipolar plates and methods for manufacturing bipolar plates are provided. A method for fabricating a composite fuel cell bipolar plate includes providing a spread-tow woven carbon fiber fabric having an upper layer of fibers and a lower layer of fibers, wherein the fabric has a thickness of less than 200 micrometers (μm); segmenting at least one of the layers of fibers at selected locations to form slits; forming the fabric and resin into a half plate shape to form a plurality of half plates, wherein each half plate comprises a series of lands and walls; and forming the bipolar plate by aligning and bonding respective lands of a first half plate and a second half plate.

### INTRODUCTION

The technical field relates generally to proton-exchange membrane (PEM) fuel cells, and more particularly to bipolar plates separating adjacent fuel cells in a fuel cell stack.

Fuel cells have been used as a power source in many applications. For example, fuel cells have been proposed for use in electrical vehicular power plants to replace internal combustion engines. In proton exchange membrane type fuel cells, hydrogen is supplied to the anode of the fuel cell and oxygen is supplied as the oxidant to the cathode. The oxygen can be either a pure form (O₂) or air (a mixture of O₂ and N₂). Proton exchange membrane fuel cells include a membrane electrode assembly (MEA) comprising a thin, proton transmissive, non-electrically conductive, solid polymer electrolyte membrane having the anode catalyst on one face and the cathode catalyst on the opposite face.

The membrane electrode assembly is sandwiched between a pair of non-porous, electrically conductive elements or plates which pass electrons from the anode of one fuel cell to the cathode of the adjacent cell of a fuel cell stack; contain appropriate channels and/or openings formed therein for distributing the fuel cell's gaseous reactants over the surfaces of the respective anode and cathode catalysts; and contain appropriate channels and/or openings formed therein for distributing appropriate coolant throughout the fuel cell stack in order to maintain temperature.

The electrically conductive plates sandwiching the membrane electrode assemblies may contain an array of grooves in the faces thereof that define a reactant flow field for distributing the fuel cell's gaseous reactants (i.e., hydrogen and oxygen in the form of air) over the surfaces of the respective cathode and anode. These reactant flow fields generally include a plurality of lands that define a plurality of flow channels therebetween through which the gaseous reactants flow from a supply header at one end of the flow channels to an exhaust header at the opposite end of the flow channels.

The term “fuel cell” is typically used to refer to either a single cell or a plurality of cells (stack) depending on the context. A plurality of individual cells are typically bundled together to form a fuel cell stack and are commonly arranged in electrical series. Each cell within the stack includes the membrane electrode assembly described earlier, and each such membrane electrode assembly provides its increment of voltage. A group of adjacent cells within the stack is referred to as a cluster.

In a fuel cell stack, a plurality of cells are stacked together in electrical series while being separated by a gas impermeable, electrically conductive bipolar plate. In some instances, the bipolar plate is an assembly formed by securing a pair of thin metal sheets having reactant flow fields formed on their external face surfaces. Typically, an internal coolant flow field is provided between the plates of the bipolar plate assembly. It is also known to locate a spacer plate between the plates to optimize the heat transfer characteristics for improved fuel cell cooling.

It would be desirable to provide bipolar plates and methods for fabricating bipolar plates with significant mass reduction. Furthermore, other desirable features and characteristics of the present disclosure will become apparent from the subsequent detailed description and the appended claims, taken in conjunction with the accompanying drawings and the foregoing introduction.

### SUMMARY

In one embodiment, a method for fabricating a composite fuel cell bipolar plate includes providing a spread-tow woven carbon fiber fabric having an upper layer of fibers and a lower layer of fibers, wherein the fabric has a thickness of less than 200 micrometers (μm); segmenting at least one of the layers of fibers at selected locations to form slits; forming the fabric and resin into a half plate shape to form a plurality of half plates, wherein each half plate includes a series of lands and walls; and forming the bipolar plate by aligning and bonding respective lands of a first half plate and a second half plate.

In certain embodiments of the method, the resin is selected from polyethylenimine (PEI), polyphenylene sulfide (PPS), polyphenylsulfone (PPSU), Polyether Ether Ketone (PEEK), and Polyether Ketone Ketone (PEKK) resins.

In certain embodiments of the method, the resin is added to the fabric before segmenting.

In certain embodiments of the method, the resin is added to the fabric after segmenting.

In certain embodiments of the method, the resin is present as a fiber in the fabric.

In certain embodiments of the method, a metallic fiber is present in the fabric.

In certain embodiments, the method further includes decreasing a contact resistance of the half plates.

In certain embodiments of the method, decreasing the contact resistance of the half plates includes abrading the lands, graphitizing the fibers or fabric, and/or metallizing the fibers or fabric.

In certain embodiments of the method, forming the fabric into a half plate shape includes pressing the fabric in a die press; and the die press presses land locations to a land thickness and presses wall locations to a wall thickness greater than the land thickness such that the resin flows from the land locations to the wall locations.

In certain embodiments of the method, wherein forming the fabric and resin into a half plate shape to form a plurality of half plates includes forming an active area of each half plate from the fabric and resin; and the method further includes forming a non-active frame of at least one half plate from the resin, wherein edges of the active area are sealed to the non-active frame by re-melting the resin.

In another embodiment, a method for manufacturing a bipolar plate useful in a fuel cell having a plurality of membrane electrode assemblies (MEAs) is provided. The method includes providing a spread-tow woven carbon fiber fabric having an upper layer of fibers and a lower layer of fibers; forming the fabric and resin into a half plate shape to form a plurality of half plates, wherein each half plate has a first surface defined by first lands configured to face a respective MEA; each half plate has a second surface defined by second lands configured to face the second lands of an adjacent half plate; and each half plate has an active area formed from the fabric and resin; and assembling the bipolar plate by aligning and bonding together the second lands of two respective half plates.

In certain embodiments of the method, a selected half plate has an inactive area formed from the resin, and the fabric is not present in the inactive area.

In certain embodiments of the method, forming the fabric into a half plate shape includes pressing the fabric in a die press; and the die press presses land locations to a land thickness and presses wall locations to a wall thickness greater than the land thickness such that the resin flows from the land locations to the wall locations.

In certain embodiments, the method further includes decreasing a contact resistance of the half plates by abrading the lands, graphitizing the fibers or fabric, and/or metallizing the fibers or fabric.

In another embodiment, a composite fuel cell bipolar plate is provided and includes a first half plate and a second half plate, wherein each half plate comprises a spread-tow woven carbon fiber fabric impregnated with resin, and wherein the fabric has a thickness of less than 200 micrometers (μm).

In certain embodiments of the composite fuel cell bipolar plate, each half plate comprises a series of lands and walls; each land has a land thickness; and each wall has a wall thickness greater than the land thickness.

In certain embodiments of the composite fuel cell bipolar plate, the spread-tow woven carbon fiber fabric is graphitized.

In certain embodiments of the composite fuel cell bipolar plate, the spread-tow woven carbon fiber fabric is electroplated with nickel.

In certain embodiments of the composite fuel cell bipolar plate, the spread-tow woven carbon fiber fabric further comprises metallic fibers.

In certain embodiments of the composite fuel cell bipolar plate, each half plate includes an active area and a non-active area; the active area of each half plate is formed from the spread-tow woven carbon fiber fabric impregnated with resin; and for at least one of the half plates, the non-active area is formed by resin.

### DESCRIPTION OF THE DRAWINGS

The present disclosure will hereinafter be described in conjunction with the following drawing figures, wherein like numerals denote like elements, and wherein:

FIG. 1 is a schematic isometric exploded illustration of a PEM fuel stack incorporating a bipolar plate assembly in accordance with certain embodiments herein;

FIG. 2 is a plan view of a bipolar plate assembly used within the fuel cell of FIG. 1 in accordance with certain embodiments herein;

FIG. 3 is a partial cross-sectional view of a bipolar plate assembly located against the sides of adjacent membrane electrode assemblies in accordance with certain embodiments herein;

FIG. 4 is a partial cross-sectional view of a half plate used in the bipolar plate assembly of FIG. 3 in accordance with certain embodiments herein;

FIGS. 5-7 are plan views of a spread-tow carbon fiber woven fabric used for fabricating the half plate of FIG. 4 in accordance with certain embodiments herein;

FIGS. 8-11 are partial cross-sectional view of a spread-tow carbon fiber woven fabric used for fabricating the half plate of FIG. 4 in accordance with certain embodiments herein;

FIG. 12 is a schematic view of a die press for forming a half plate from a carbon fiber fabric; and

FIG. 13 is a flow chart illustrating a method for fabricating a bipolar plate assembly in accordance with certain embodiments herein.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description. As used herein, the term module refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of automated driving systems including cruise control systems, automated driver assistance systems and autonomous driving systems, and that the vehicle system described herein is merely one example embodiment of the present disclosure.

Finally, for the sake of brevity, conventional techniques and components related to vehicle mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment. It should also be understood that the figures are merely illustrative and may not be drawn to scale.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

An exemplary carbon fiber composite fuel cell bipolar plate and a method for manufacturing a carbon fiber composite fuel cell bipolar plate are provided.

Certain embodiments provide for extremely lightweight fuel cell bipolar plates when compared to stainless steel bipolar plates. For example, bipolar plates herein may have a greater than seventy percent reduction in mass as compared to stainless steel bipolar plates. Also, embodiments of carbon fiber composite bipolar plates described herein lack iron, unlike those made from stainless steels. Iron causes degradation in proton-exchange membrane fuel cells. The elimination of iron from bipolar plates in the embodiments described herein results in fuel cells having longer life spans. Further, embodiments herein provide for much thinner and lighter composite bipolar plates as compared to bipolar plates made from flexible graphite composites. Also, capital costs for equipment needed for forming carbon composite bipolar plates may be less capital intensive than for other types of bipolar plates.

Certain embodiment herein provide for cutting the woven fabric before forming the fabric into the shape of a half plate. Cutting slits into the woven fabric may relieve stress or otherwise allow the fabric to be shaped into the desired form without wrinkling.

Certain embodiments impregnate the woven fabric with a thermoplastic that can be re-heated and re-melted multiple times during processing. For example, a thermoplastic film or films can be located over or around the fabric and heated to melt and fill in gaps in the fabric. Alternatively or additionally, a resin fiber or fibers may be woven into the fabric such that, upon application of heat, the resin melts and flows throughout the fabric to fill in gaps in the fabric. It is contemplated that the slits be cut into the fabric before or after the thermoplastic is applied to the fabric and before or after the thermoplastic is heated to fill in gaps.

Certain embodiments herein provide for improving the conductivity of carbon fiber composite fuel cell bipolar plates. For example, half plates may be formed from fabric that includes carbon fibers and metallic fibers to increase conductivity. In certain embodiments, carbon fibers may be graphitized and/or electroplated to increase conductivity. In certain embodiments, in areas in which decreased contact resistance is desired, such as in lands of the half plate, the fabric is squeezed during forming to force the resin to flow out of the areas to provide the areas with a thinnest thickness, a maximum fiber density, and increased electrical conductivity.

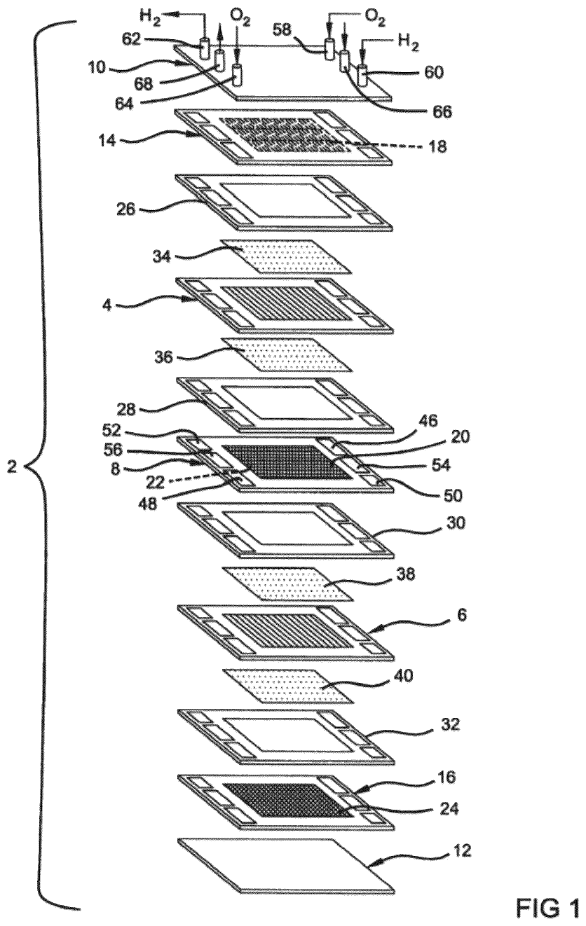

With reference to FIG. 1, certain features of a generalized bipolar plate stack are illustrated. In FIG. 1, a two-cell stack (i.e., one bipolar plate) is illustrated and described hereafter, it being understood that a typical stack will have many more such cells and bipolar plates. FIG. 1 depicts a two-cell bipolar PEM fuel cell stack 2 having a pair of membrane-electrode-assemblies (MEAs) 4 and 6 separated from each other by an electrically conductive, liquid-cooled bipolar plate 8. The MEAs 4 and 6 and bipolar plate 8 are stacked together between clamping plates 10 and 12 and monopolar end plates 14 and 16. The clamping plates 10 and 12 are electrically insulated from the ends plate 14 and 16. The working face of each monopolar end plates 14 and 16, as well as both working faces of the bipolar plate 8 contain a plurality of grooves or channels 18, 20, 22 and 24 defining a so-called “flow field” for distributing fuel and oxidant gases (i.e., H₂ and O₂) over the faces of the MEAs 4 and 6. Nonconductive gaskets 26, 28, 30 and 32 provide seals and electrical insulation between the several components of the fuel cell stack. Gas-permeable diffusion media 34, 36, 38, and 40 press up against the electrode faces of the MEAs 4 and 6. The end plates 14 and 16 press up against the diffusion media 34 and 40 respectfully, while the bipolar plate 8 presses up against the diffusion media 36 on the anode face of MEA 4, and against the diffusion media 38 on the cathode face of MEA 6

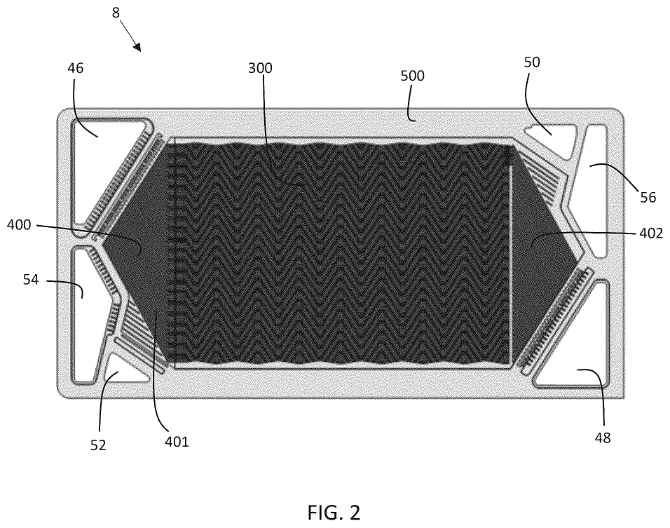

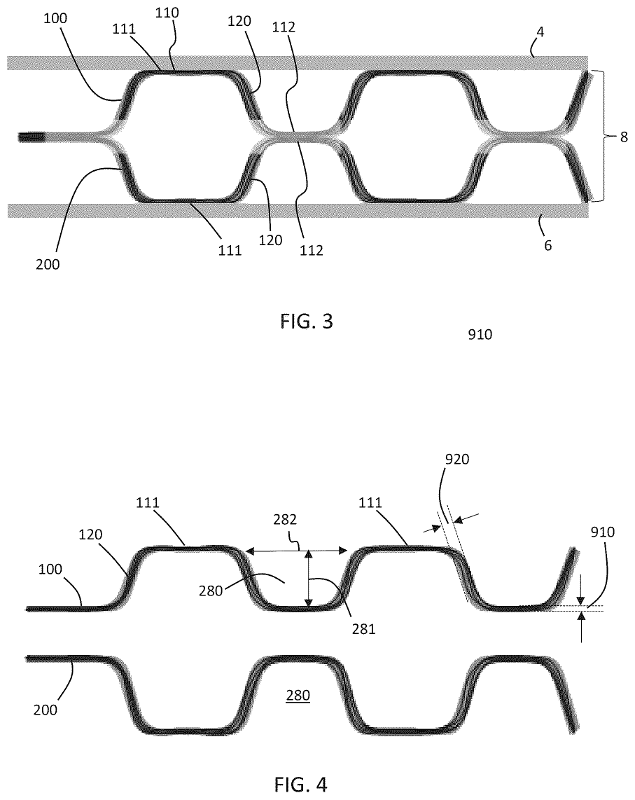

With reference to FIGS. 2-4, the bipolar plate assembly 8 includes two separate half plates 100 and 200 which are bonded together so as to define a coolant volume therebetween. FIG. 2 provides a plan view of the bipolar plate assembly 8, FIG. 3 provides a partial cross-sectional view of the bipolar plate assembly 8 located against the sides of adjacent membrane electrode assemblies 4 and 6 (with diffusion media not shown in the view of FIG. 3), and FIG. 4 is a partial cross-sectional view of the half plates exploded and in isolation.

FIG. 2 illustrates that the bipolar plate 8 (and each half plate 100 and 200) includes a central active area 300 and non-active areas or margins 400. The central active area 300 confronts the MEAs 4 and 6 (shown in FIG. 1) and is bounded by inactive regions or margins 400. As further shown, the non-active areas 400 and active area 300 are surrounded by a frame 500.

The anode half plate 100 has a working face with an anode flow field including a plurality of serpentine flow channels for distributing hydrogen over the anode face of the MEA 4. Likewise, the cathode plate 200 has a working face with a cathode flow field including a plurality of serpentine flow channels for distributing oxygen (often in the form of air) over the cathode face of the MEA 6. The active region 300 of the bipolar plate 8 is flanked by two inactive border portions or margins 401 and 402 that have openings 46, 48, 50, 52, 54, and 56 formed therethrough. When the anode and cathode plates 100, 200 are stacked together, the openings 46, 48, 50, 52, 54, and 56 in the plates 100 and 200 are aligned with like openings in adjacent bipolar plate assemblies. Other components of the fuel cell stack 2 such as gaskets 26, 28, 30 and 32 as well as the membrane of the MEAs 4 and 6 and the end plates 14 and 16 have corresponding openings that align with the openings in the bipolar plate assembly in the stack, and together form headers for supplying and removing gaseous reactants and liquid coolant to/from the stack.

In the embodiment shown in the figures, opening 46 in a series of stacked plates forms an air inlet header, opening 48 in series of stacked plates forms an air outlet header, opening 50 in a series of stacked plates forms a hydrogen inlet header, openings 52 in a series of stacked plates forms a hydrogen outlet header, opening 54 in a series of stacked plates forms a coolant inlet header, and opening 56 in a series of stacked plates forms a coolant outlet header. Inlet plumbing 58, 60 for both the oxygen/air and hydrogen may be in fluid communication with the inlet headers 46, 50 respectively. Likewise, exhaust plumbing 62, 64 for both the hydrogen and the oxygen/air may be in fluid communication with the exhaust headers 48, 52 respectively. Additional plumbing 66, 68 is provided for respectively supplying liquid coolant to and removing coolant from the coolant header 54, 56.

FIG. 3 is a partial cross-sectional view of a bipolar plate 8, taken along a portion of the active area 300. In the active area 300, the half plates 100 and 200 are formed with a pattern or series of lands 110 and walls 120. As shown, each half plate 100 and 200 includes outward-facing lands 111 for contact with a respective MEA 4 and 6, and inward-facing lands 112 for contact with an inward-facing land of the other half plate. Each wall 120 extends between and interconnects an outward-facing land 111 and an adjacent inward-facing land 112.

In embodiments herein, the active region 300 of each half plate 100 and 200 is formed from a carbon fiber fabric 600.

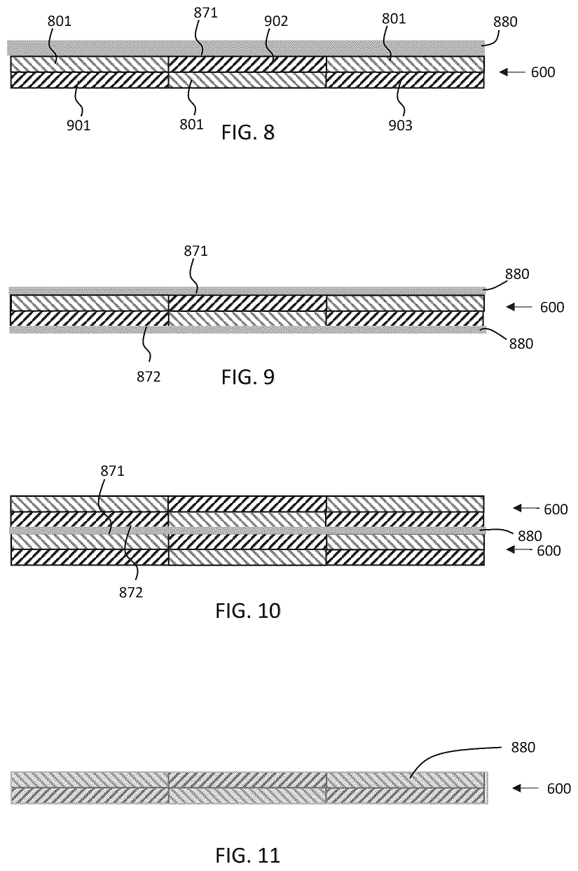

Plan views of embodiments of the carbon fiber fabric 600 are provided in FIGS. 5, 6, and 7. Cross-sectional views of the carbon fiber fabric 600, during a stage of manufacturing, are shown in FIGS. 8, 9, and 10. A cross-sectional view of the carbon fiber fabric 600 is shown in FIG. 11.

As indicated by FIGS. 5-11, the carbon fiber fabric 600 is formed by a weave, such as a basket weave, of tapes or bands of spread tow carbon fibers. A “spread tow” of carbon fibers includes a bundle of fibers that are spread into a thinner, flatter reinforcement, for example a five millimeter wide carbon fiber tow may be commonly spread to a twenty-five millimeter width unidirectional tape having a thickness of less than two hundred micrometers, such as less than one hundred millimeters. The tow may include about one-hundred fibers that are spread out to a thickness of five to fifteen fibers. Each fiber may be about seven micrometers thick. The unidirectional tape is woven into the fabric 600 including at least two layers in certain embodiments. For example, as indicated in FIG. 5, parallel bands 801 and 802 extend in first direction and pass over and under a series of parallel bands 901-908 that extend in a second direction perpendicular to the first direction. The fabric 600 may include any number of bands 800 and bands 900 necessary for the desired length and width of the fabric 600. While FIGS. 5-7 indicate that the bands 800 and 900 are arranged at angle of zero degrees and ninety degrees with respect to the edges of the fabric 600, other orientations such as negative forty-five degrees and positive forty-five degrees are contemplated. In certain embodiments, the fabric 600 may weigh as little as fifteen g/m² with a thickness of 200 micrometers.

In order prevent wrinkling or other undesired issues when forming the fabric 600 into the shape of a half plate 100 or 200, the fabric 600 may be partially cut to prevent build up of mechanical stresses. Specifically, one layer of the fabric 600, such as band 801, may be cut to form slits 850 while the underlying band, such as band 901, remains uncut. In certain embodiments, each slit 850 is formed at a perpendicular angle to the fiber direction of the respective band 800 or 900. For example, in FIG. 5, band 801 extends laterally to the left and right, and the slits 850 formed in band 801 extend vertically up and down. Thus, the slits 850 are aligned with the direction of the fibers in the underlying bands 900. During processing, the fibers in the underlying bands 900 may fill in the slits 850.

FIGS. 5-7 illustrate various embodiments for arranging the size, orientation, and pattern of the slits 850. In FIG. 5, each slit 850 extends across the entire width of the respective band 800 or 900. Further, each visible square of top layer 800 or 900 includes a slit 850, and each slit 850 is centered in the square of top layer 800 or 900. In other embodiments, fewer slits 850 may be formed in the fabric 600, or may be formed only in regions that undergo more bending when being formed into the shape of a half plate 100 or 200.

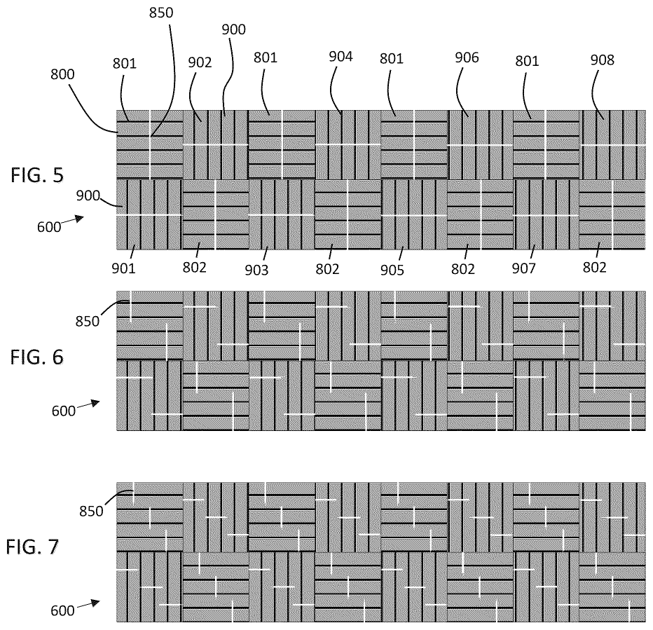

In FIG. 6, the slits 850 do not extend across the full width of each band 800 and 900. Instead, each slit 850 has a length equal to about one-half of the width of each band 800 and 900. Further, the slits 850 are arranged and spaced from one another by about one half of the width of the layer.

In FIG. 7, each slit 850 has a length equal to about one-third of the width of each band 800 and 900. Further, the slits 850 are arranged and spaced from one another by about one-third of the width of the layer.

FIGS. 5-7 merely present possible arrangements of slits 850. Other arrangements are contemplated. As indicated above, such arrangements may be used in certain areas of the fabric 600 that may be prone to wrinkling or other structure defects. Further, multiple arrangements of slits 850 may be used in different areas of the same fabric 600.

FIGS. 8-10 illustrate the combination of the fabric 600 with a thermoplastic material 880. For example, as shown in FIG. 8, a thermoplastic material 880 may be provided in the form of a film and located over one surface 871 of the fabric 600. During or before forming into the shape of a half plate 100 or 200, the thermoplastic material 880 may be heated and may melt to flow between the carbon fibers, into gaps of the weave, and into the slits.

FIG. 9 illustrates that two films of thermoplastic material 880 may be used, with each film located against a respective surface 871 or 872 of the fabric 600. During or before forming into the shape of a half plate 100 or 200, the thermoplastic material 880 may be heated and may melt to flow between the carbon fibers, into gaps of the weave, and into the slits.

FIG. 10 illustrates that a single film of thermoplastic material 880 may be used with two pieces of fabric 600. Specifically, the film of thermoplastic material 880 may be located against the surface 871 of one piece of fabric 600 and against the surface 872 of another piece of fabric 600. During or before forming into the shape of a half plate 100 or 200, the thermoplastic material 880 may be heated and may melt to flow between the carbon fibers, into gaps of the weave, and into the slits.

Also, the thermoplastic material 880 may be present as a fiber or fibers within the fabric 600. Thus, without needing the additional step of locating a film of thermoplastic material 880 over the fabric 600, the thermoplastic material 880 may be heated and flow between the carbon fibers, into gaps of the weave, and into the slits.

FIG. 11 illustrates a single woven layer of fabric 600, such as from FIGS. 8 and 9, after being impregnated with thermoplastic material 880. As shown, the thermoplastic material 880 fills in around carbon fibers and fills any gaps or slits in the weave.

In the embodiments of FIGS. 8-11, the thermoplastic material or resin 880 may be or comprise polyethylenimine (PEI), polyphenylene sulfide (PPS), polyphenylsulfone (PPSU), Polyether Ether Ketone (PEEK), and/or Polyether Ketone Ketone (PEKK) resins. Any thermoplastic material having suitable material, compatibility strength and permeability properties may be used. For example, the bipolar plates should not permeate hydrogen or coolant across the thickness of the plate, thus a good distribution of thermoplastic preventing permeability of such materials is desirable. In certain embodiments, it is desirable to select a material that may be re-heated and re-set multiples times without suffering performance defects.

It is noted that in the embodiments of fabric 600 described in relation to FIGS. 5-11, the fibers in the bands 800 extend in a longitudinal direction from end to end of the fabric 600 and substantially perpendicular to the surface of the fabric 600, and the fibers in the bands 900 extend in a lateral direction from end to end of the fabric 600 and substantially perpendicular to the surface of the fabric 600.

Referring back to FIGS. 2-4, the fabric 600 is molded to form at least the active region 300 of each half plate 100 or 200. In certain embodiments, the fabric 600 is molded to form the active region 300, the inactive regions 400, and the frame 500 of the half plate 100 or 200. In other embodiments, the fabric 600 is not present in the frame 500. Rather, the frame is formed only from resin or thermoplastic, such as the same thermoplastic 880 impregnated in the fabric 600. In other embodiments, the fabric 600 is not present in the inactive regions 400 or the frame 500. Rather, the inactive regions 400 and frame 500 are formed only from resin or thermoplastic, such as the same thermoplastic 880 impregnated in the fabric 600.

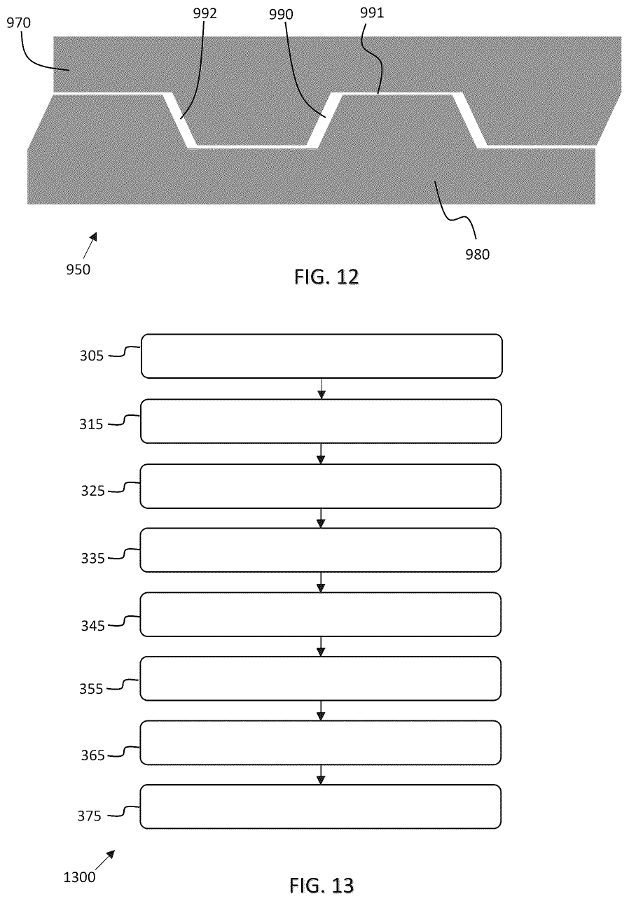

FIG. 12 illustrates a die press 950 that may be used to form the fabric 600 into the shape of a half plate 100 or 200. The die press 950 may include a movable punch 970 and a die plate 980 that are formed to define a void space 990 in the shape of the respective half plate 100 or 200. As shown, land areas 991 of the void space have a smaller thickness than wall areas 992 of the void space 990.

Thus, a piece of fabric 600 may be formed into the shape of the half plate 100 or 200 by the die press 950, with a series of lands 110 and walls 120 corresponding to the land areas 991 and wall areas 992. As indicated in FIG. 4, each land 110 has a thickness 910 and each wall 120 has a thickness 920. The thickness 920 of the walls 120 is greater than the thicknesses 910 of the lands 110.

During forming by the die press 950, thermoplastic material 880 may be squeezed from the lands 110 and flow into the walls 120, thereby reducing the thickness of the lands 110 to thickness 910 and increasing the thickness of the walls 120 to thickness 920. In certain embodiments, the lands 110 are squeezed such that the lands 110 have a maximum carbon fiber density.

Each half plate 100 and 200 includes openings 280 formed between adjacent outward-facing lands 111. Each opening has a depth 281. In certain embodiments, the depth 281 is from three-hundred to four-hundred micrometers. Further, each opening has a width 282. In certain embodiments, the width 282 is about one millimeter.

FIG. 13 is a flow chart illustrating a method 1300 for fabricating a bipolar plate. Method 1300 includes, at 315, providing a spread-tow woven carbon fiber fabric having an upper layer of fibers and a lower layer of fibers. In certain embodiments, the fabric has a thickness of less than 200 micrometers (μm), such as less than 100 micrometers. In certain embodiments, the fabric includes metallic conductive fibers in addition to carbon fibers. In certain embodiments, the fabric includes thermoplastic fibers in addition to carbon fibers.

Method 1300 includes, at 325, segmenting at least one of the layers of fibers at selected locations to form slits. Cutting one layer of fabric may allow movement of fiber segments during later processing to prevent wrinkling.

Method 1300 includes, at 335, melting a resin or thermoplastic material into the fabric to form a thermoplastic impregnated fabric. In certain embodiments, the thermoplastic material is present in the fabric in the form of thermoplastic fibers. In other embodiments, a film of thermoplastic material is brought into contact with the fabric and melted, i.e., the fabric is laminated with thermoplastic material.

It is noted that operation 325 may be performed before or after operation 335.

Certain embodiments may include at 345, calendaring the thermoplastic impregnated fabric to a desired thickness to provide proper resin loading control and to eliminate porosity in the fabric. In other embodiments, control of resin loading may be performed by determining the amount of thermoplastic per area of fabric and providing the precise amount of thermoplastic, whether as thermoplastic fibers integrated with the fabric or as a film of thermoplastic.

Method 1300 includes, at 355, forming the thermoplastic impregnated fabric into a half plate shape to form a plurality of half plates, wherein each half plate comprises a series of lands and walls. For example, a die press may be used to form the thermoplastic impregnated fabric into the half plate shape. In such embodiments, the die press may press land locations to a land thickness and press wall locations to a wall thickness greater than the land thickness such that resin flows from the land locations to the wall locations. In other embodiments, roll forming may be used to form the thermoplastic impregnated fabric into a half plate shape to form a plurality of half plates.

It is noted that operation 335 may be performed in conjunction with operation 355, such that the thermoplastic material is melted during the forming process.

Thus method 1300 may include preheating the fabric and thermoplastic material before the fabric is pressed into form. The die press or other molding forms may be cooled or may be heated.

Method 1300 includes, at 365, decreasing a contact resistance of the half plate. Certain embodiments may include decreasing the contact resistance of the half plate by abrading the half plate, such as by abrading the lands between the half plates and between the bipolar plate and soft goods (GDM, MPL and MEA) of each cell, and other areas of desired electrical contact, such as by sanding or grinding prior to joining the half plates into a bipolar plate. In such embodiments, operation 365 may be performed after operation 355.

In certain embodiments, the conductivity of the half plate is increased by increasing the conductivity of the fabric at operation 305. Certain embodiments may include providing metallic fibers in the fabric at operation 305. Certain embodiments may include increasing conductivity of the fabric by graphitizing the fibers to a desired degree and/or coating the fibers with a layer of metal that is robust to the PEM fuel cell environment at operation 305. The metallized coating may be achieved through electroplating, chemical vapor deposition on, or thermal spraying the fibers. Electroplating may be performed with a metal compatible with the fuel cell environment, such as nickel. Gold may also be suitable.

In certain embodiments, conductivity of the fabric may be increased by adding a conductive additive to the thermoplastic or resin material. For example, graphene may be added to thermoplastic fibers or to thermoplastic films before used with the fabric.

Forming the thermoplastic impregnated fabric into a half plate shape with a reduced thickness at the lands may also be considered to decrease the contact resistance of the lands by creating a fiber rich contact surface.

Increased conductivity may be particularly desired in the portions of the finished half plates 100 and 200 to provide sufficiently low contact resistance to adjacent half plates and/or the MEA layers in the active region of the cell.

Method 1300 includes, at 375, forming the bipolar plate by aligning and bonding respective lands of a first half plate and a second half plate. For example, the respective lands may be bonded to one another by heat staking or ultrasonic welding.

It is noted that the bipolar plate may be formed by half plates of different structural arrangements. While both half plates have an active region formed by the carbon fiber reinforced plastic, the non-active margins and frames may or may not be formed from the same carbon fiber reinforced plastic. For example, the non-active margins and/or frames may be formed from thermoplastic or resin only. Thus, one half plate may be entirely carbon fiber reinforced plastic and the other half plate may be partially carbon fiber reinforced plastic and partially only thermoplastic or resin.

In certain embodiments of the method 1300, forming the fabric and resin into a half plate shape to form a plurality of half plates including forming an active area of each half plate from the fabric and resin; and the method further includes forming a non-active frame of at least one half plate from the resin, wherein edges of the active area are sealed to the non-active frame by re-melting the resin.

As described herein, a composite fuel cell bipolar plate is made from very thin spread-tow woven carbon fiber fabric. Modifications to the carbon fiber fabric may provide sufficient electrical conductivity. These modifications may entail electroplating and/or graphitization of the carbon fibers and/or integrating metallic fibers in the fabric. Modifications may be made to the carbon fiber fabric by segmenting the fibers while maintaining the integrity of the fabric. The segmented carbon fibers may allow the carbon fibers to be more easily drawn into the features of the half plate during forming.

In certain embodiments, a process step of producing a flat carbon fiber composite material prior to forming the half plate assures proper and uniform fiber/resin ratio, uniform film thickness and sufficiently low permeability to fuel cell reactants and coolants. In certain embodiments, a thermoplastic resin is used to create the composite material with the fabric.

In certain embodiments, a resin that is chemically compatible with the fuel cell electrochemical layers (MEA, electrodes, etc.), while providing sufficiently high strength, sufficiently low permeability to hydrogen and coolant under the hot, wet, fuel cell environment is selected. Examples of such resins may be in the polyethylenimine (PEI), polyphenylene sulfide (PPS), polyphenylsulfone (PPSU), Polyether Ether Ketone (PEEK), and Polyether Ketone Ketone (PEKK) families of engineering resins. In certain embodiments, the resin formulation may contain additives to make the resin electrically conductive. Such additives are selected such that the additives do not leach out into the fuel cell fluid streams and cause damage the electrochemical layers or increase conductivity of the fuel cell coolant. In certain embodiments, the resin may be in the form of thin films that are melted to impregnate the carbon fiber fabric. In such embodiments, the thin films may be applied from one or both sides of the fabric. In other embodiments, the thin film may be sandwiched between two layers of fabric. In some embodiments, the resin could be in the form of thin fibers (with diameters similar to those of the carbon fibers) that are woven into the carbon fiber fabric during the spread-tow weaving process. In such embodiments, the ratio of resin fibers to carbon fibers may be selected to establish a fiber/resin ratio that results in a solid composite film.

Certain embodiments include a forming die design that emphasizes squeezing the composite in areas that require carbon fibers to provide low electrical contact resistance at the adjoining surfaces (lands) of the half plates and in the bipolar plate active area at the electrically conductive contact surfaces (lands) between the flow field and the diffusion media/MEA assembly. For example, the die may be designed such that the side wall thickness of the flow channels is increased to accept resin that is squeezed out of the thin, fiber-dense land sections.

In certain embodiments, a bipolar plate design includes half plates that are comprised of a carbon fiber composite active areas with a frame made entirely of resin, where the edges of the composite active area are bonded and sealed to the frame through remelting the resins.

In certain embodiments, a bipolar plate design includes one half plate that is comprised of a carbon fiber composite active area with a resin frame and another half plate that is made entirely of carbon fiber composite.

In certain embodiments, a bipolar plate fabrication process remelts the thermoplastic resin to join and seal the half plates together while establishing sufficient electrical conductivity at the contact points between the two half plates.

In certain embodiments, a cell assembly process utilizes heat-staking the subgasket of the UEA (MEA plus polymeric carrier frame) to the composite bipolar plate assembly. In such embodiments, the heat staking process may include melting the resin in the bipolar plate and/or the resin in the subgasket.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing summary and detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for fabricating a composite fuel cell bipolar plate comprising:
providing a spread-tow woven carbon fiber fabric having an upper layer of fibers and a lower layer of fibers, wherein the fabric has a thickness of less than 200 micrometers (μm);
segmenting at least one of the layers of fibers at selected locations to form slits;
forming the fabric and resin into a half plate shape to form a plurality of half plates, wherein each half plate comprises a series of lands and walls; and
forming the bipolar plate by aligning and bonding respective lands of a first half plate and a second half plate.

2. The method of claim 1, wherein the resin is selected from polyethylenimine (PEI), polyphenylene sulfide (PPS), polyphenylsulfone (PPSU), Polyether Ether Ketone (PEEK), and Polyether Ketone Ketone (PEKK) resins.

3. The method of claim 1, wherein the resin is added to the fabric before segmenting.

4. The method of claim 1, wherein the resin is added to the fabric after segmenting.

5. The method of claim 1, wherein the resin is present as a fiber in the fabric.

6. The method of claim 1, wherein a metallic fiber is present in the fabric.

7. The method of claim 1, further comprising decreasing a contact resistance of the half plates.

8. The method of claim 7, wherein decreasing the contact resistance of the half plates comprises abrading the lands, graphitizing the fibers or fabric, and/or metallizing the fibers or fabric.

9. The method of claim 1, wherein:
forming the fabric into a half plate shape comprises pressing the fabric in a die press; and
the die press presses land locations to a land thickness and presses wall locations to a wall thickness greater than the land thickness such that the resin flows from the land locations to the wall locations.

10. The method of claim 1, wherein:
forming the fabric and resin into a half plate shape to form a plurality of half plates comprises forming an active area of each half plate from the fabric and resin; and
the method further comprises forming a non-active frame of at least one half plate from the resin, wherein edges of the active area are sealed to the non-active frame by re-melting the resin.

11. A method for manufacturing a bipolar plate useful in a fuel cell having a plurality of membrane electrode assemblies (MEAs), the method comprising:
providing a spread-tow woven carbon fiber fabric having an upper layer of fibers and a lower layer of fibers;
forming the fabric and resin into a half plate shape to form a plurality of half plates, wherein:
each half plate has a first surface defined by first lands configured to face a respective MEA;
each half plate has a second surface defined by second lands configured to face the second lands of an adjacent half plate; and
each half plate has an active area formed from the fabric and resin; and
assembling the bipolar plate by aligning and bonding together the second lands of two respective half plates.

12. The method of claim 11, wherein a selected half plate has an inactive area formed from the resin, wherein the fabric is not present in the inactive area.

13. The method of claim 11, wherein:
forming the fabric into a half plate shape comprises pressing the fabric in a die press; and
the die press presses land locations to a land thickness and presses wall locations to a wall thickness greater than the land thickness such that the resin flows from the land locations to the wall locations.

14. The method of claim 13, further comprising decreasing a contact resistance of the half plates by abrading the lands, graphitizing the fibers or fabric, and/or metallizing the fibers or fabric.

15. A composite fuel cell bipolar plate comprising:
a first half plate and a second half plate, wherein each half plate comprises a spread-tow woven carbon fiber fabric impregnated with resin, and wherein the fabric has a thickness of less than 200 micrometers (μm).

16. The composite fuel cell bipolar plate of claim 15, wherein:
each half plate comprises a series of lands and walls;
each land has a land thickness; and
each wall has a wall thickness greater than the land thickness.

17. The composite fuel cell bipolar plate of claim 15, wherein the spread-tow woven carbon fiber fabric is graphitized.

18. The composite fuel cell bipolar plate of claim 15, wherein the spread-tow woven carbon fiber fabric is electroplated with nickel.

19. The composite fuel cell bipolar plate of claim 15, wherein the spread-tow woven carbon fiber fabric further comprises metallic fibers.

20. The composite fuel cell bipolar plate of claim 15, wherein:
each half plate includes an active area and a non-active area;
the active area of each half plate is formed from the spread-tow woven carbon fiber fabric impregnated with resin; and
for at least one of the half plates, the non-active area is formed by resin.
